(19) United States
(12) Patent Application Publication
(10) Pub. No.: US 2002/0144959 A1
(43) Pub. Date: Oct. 10, 2002

(54) Expanded methods for purifying a solvent

(76) Inventors: David Deck Rendina, North Vancouver (CA); Beverlee Lynn Jones, North Vancouver (CA); Kathleen Mary Nikl, Vancouver (CA)

Correspondence Address: MR. ANTONY EDWARDS, C/O Bishop & COMPANY, #206 - 347 LEON AVE., KELOWNA, BC, V1Y8C7, CA

(21) Appl. No.: 09/826,647

(22) Filed: Apr. 5, 2001

(51) Int. Cl. C02F 1/68

(52) U.S. Cl. 210/764

(57) ABSTRACT

The present invention relates primarily to the field of water purification. Expanded inclusive methods for purifying polar solvents are disclosed. Said expanded methods include unique means for removing life forms, such as microorganisms, from polar solvents. The process is useful in the rapid and efficient removal of suspended living and dead microorganisms, or other biological material from polar solvents.

### BACKGROUND OF INVENTION

The present invention relates primarily to the field of water purification contaminated by living microorganisms. Disclosed are inclusive methods for capturing microorganisms suspended in water. The process is useful in the rapid and efficient removal of suspended microorganisms, from polar solvents such as water.

Methods for exfoliating layered materials have been disclosed by many researchers including those described in U.S. Pat. No. 4,822,590 to Morrison et al, titled “Forms of Transition Metal Dichalcogenides”.

In U.S. Pat. No. 5,932,372 to Rendina dated Aug. 3, 1999 and titled “Inclusion Methods for Purifying a Solvent” new inclusive methods for purifying polar solvents were disclosed. These methods employ finely divided layered materials, preferably exfoliated layered materials, homogeneously dispersed and suspended in polar solvents to capture, by inclusion methods between layers, various impurities that are suspended, contained, mixed, or dissolved within the solvent.

The U.S. Pat. No. 5,932,372 patent teaches that the inclusive methods may be applied to removing industrial toxins and salts from waste streams. Living organisms are fundamentally different from industrial contaminates and salts in that they possess an inherent mobility that could potentially allow them to escape from the suspended layered materials which are used in the inclusive process. It would be beneficial if the methods could also be applied to remove living pollutants such as virus and bacteria.

In U.S. provisional patent application No. 60\194,905 filed Apr. 6, 2000, incorporated here, in its entirety, by reference, the inventors disclose methods that may be applied to utilize the structural properties of exfoliated layered materials to achieve this goal to a significant degree. However, the effectiveness of the removal of the living microorganisms was not 100%. When the intention is to utilize the methods for purifying drinking water, it would be especially beneficial if 100% of the living microorganisms could be removed.

Finally, although others, such as Divigalpitiya et al, in U.S. Pat. No. 4,996,108 entitled “Sheets of Transition Metal Dichalcogenides” have described how inclusions of various materials may be captured within the spaces separating molecular layers of exfoliated layered materials, none have described how inclusions may be made using materials selected for their effect on living matter external to or surrounding the exfoliated materials. Nor have they described efficient mechanical methods for controlling the dosage of the inclusion material delivered to the living material by means that concentrate the exfoliated layered material.

### BRIEF DESCRIPTION OF THE INVENTION

The inventors have surprisingly discovered that the inclusive methods for purifying a solvent are highly effective at removing living microorganisms from water when an excess of suspended layered materials homogenously dispersed in a miscible polar solvent is used. Further, they have discovered that the effectiveness of the removal process may be enhanced by the inclusion of minute quantities of bio-toxins, such as alcohol or others, between the sheets of the layered materials prior to dispersing them in the contaminated source water.

It is an object of the invention to disclose methods to remove living impurities from polar solvents, like water, by causing them to be included between layers of homogenously dispersed suspensions of layered materials. In the preferred embodiment of the invention the layered materials utilized would be comprised substantially of exfoliated transition metal dichalcogenides. However, other material exhibiting similar rheological properties could be used.

It is a further, object of the invention to enhance the effectiveness of the inclusion methods by modifying the materials used to perform the purifying process so that they include minute quantities of bio-toxic materials, captured within concentrated restacked layered materials, prior to dispersing them in a water source contaminated by microorganisms or other biological materials.

Although not wishing to be bound by any particular theory, the inventors believe that the methods disclosed clearly indicate that when the restacked layered materials, with minute quantities of bio-toxins contained as inclusions within layers, are dispersed in polar solvents like water, the dispersed sheets of layered materials not only encapsulate the microorganisms and separate them from the water, but also act to deliver lethal quantities of bio-toxic material directly to the organisms that they encounter.

In the preferred embodiment of the invention, the quantity of bio-toxic material would be minimized to an exact amount below the quantity necessary to cause any harm to users of the water, but sufficient to kill the microorganisms encountered. Further, for safety, it is most preferred, that the bio-toxic material included within restacked sheets of the layered materials be polar solvents, such as alcohol, that are benign to humans in much larger quantities than the minute quantities required to destroy the microorganisms.

The inventors believe that said polar solvents form a coating on the surface of each single molecule thick sheet of the exfoliated transition metal dichalcogenides such as exfoliated MoS₂ WS₂ or the like. Therefore, at its most concentrated, a suspension of these exfoliated layered materials in a bio-toxic polar solvent, restacked by centrifugal force, will contain a minimum of a uniformly dispersed, bi-molecular layer, of said polar solvent, between the restacked sheets of the exfoliated layered materials in the concentrate. Although the inventors prefer to use polar solvents as bio-toxic agents, other materials that may be immiscible, or suspended, or dissolved in polar solvents, can be captured in minute quantities between molecular layers of restacked layered materials for use as bio-toxins.

It is a further object of this application to disclose methods for capturing the required dosage of bio-toxic materials to use in the purification process, by adjusting the concentration of the suspension of layered materials.

### DETAILED DESCRIPTION OF THE INVENTION

The inventors have discovered that these objects may be accomplished by the following methods:

1. Insuring that an excess amount of a homogenous dispersion of suspended layered material in relation to the contaminants in the solvent is added to a solvent which contains impurities in the form of living microorganisms;

2. Agitating the mixture of materials in such a manner and for sufficient time to cause particles of the suspended layered materials to come into contact with the impurity.

3. Separating the layered material containing within its layers the now included impurities and a portion of the solvent from the remainder of the now pure solvent.

These methods may be further enhanced by first preparing a concentrated suspension of exfoliated layered materials with sufficient quantities of bio-toxic materials included between the restacked layers of the concentrate. The preferred method for preparing said concentrate is to suspend the selected layered materials in the desired polar solvent or a polar solvent within which the selected bio-toxic materials are immiscible, have been suspended, or are dissolved, and then concentrate to the desired consistency by centrifuging. It is important that the bio-toxic material is not forced from between the restacked layers by the application of excessive pressure or by drying in a manner that causes the sheets to be brought into contact with one another. Should this occur the sheets would not re-suspend when added to the solvent to be purified. Thus the methods described above may be modified to:

1. Preparing a concentrated suspension of exfoliated layered materials with quantities of bio-toxic materials contained as inclusions within the spaces separating restacked layers of the exfoliated layered material in the concentrate.

2. Insuring that an excess amount of said concentrated suspension of layered material with bio-toxic inclusions, in relation to the contaminants in the solvent, is added to, and homogenously dispersed in, a solvent which contains impurities in the form of living microorganisms;

3. Agitating the mixture of materials in such a manner and for sufficient time to cause particles of the suspended layered materials to come into contact with the impurity.

4. Separating the layered material containing within its layers the now included impurities, and a portion of the solvent, from the remainder of the now pure solvent.

Without wishing to be limited in the scope or in the spirit of the invention the inventors have included the following details of experiments to better illustrate how the invention may be described.

### DESCRIPTION OF EXPERIMENTS

In order to better illustrate how the process of the current invention may be utilized to expand on known inclusion methods for purifying polar solvents the following experiments were conducted.

### Experiment 1

Samples adding in total to 500 ml of water were obtained from a source known to be contaminated by biological organisms. The samples were obtained using sterile procedures in sterile containers and labeled as KB003-1 “control water”. A sample of the control water was cultured under aseptic protocols and an analysis of the culture was conducted after 48 hours which revealed that biological organisms had proliferated to a growth rate of >2000 CFU/ml.

A second sample of the control water was prepared. Approximately 0.20 ml of a suspension of exfoliated layered material suspended in distilled water at a concentration of 20 mg/ml was added by drops to 10 ml of this second sample. The mixture of contaminated water and suspended exfoliated layered material was agitated by vigorous shaking and then centrifuged at 3000 RPM for 10 minutes. After centrifuging it was noted that a small amount of dark material was agglomerated in the bottom of centrifuge tube and that the remaining water appeared to be clear and transparent. 5.0 ml of the water without sediment was transferred into another sterile container using aseptic techniques labeled KB003-4. A portion of sample KB003-4 was cultured. An analysis of the culture was conducted after 48 hours, which revealed that biological organisms had proliferated to a growth rate of 70 CFU/ml.

It can be clearly seen in the foregoing experiment that although the addition of exfoliated layered material by normal methods is useful in removing microorganisms from a contaminated water source, they are not as efficient as desired as enough bacteria remained to proliferate to a level of 70 CFU/ml.

### Experiment 2

A second series of experiments were conducted in order to determine the effect of adding excess exfoliated materials to the solvent. In this context the phrase excess is understood to mean that a significantly greater quantity of exfoliated material was used than was required to encapsulate the bacteria suspended in the water. The following experiment describes results after ten times more exfoliated material was used than was applied in the first experiment.

A third sample of the control water was prepared. Approximately 2.0 ml of a suspension of exfoliated layered material in distilled water at a concentration of 20 mg/ml was added to 10 ml of this third sample. The mixture of water and suspended exfoliated layered material was agitated by vigorous shaking and then centrifuged at 3000 RPM for 10 minutes. After centrifuging it was noted that the remaining liquid was still slightly discolored by suspended exfoliated layered material and that the centrifuge tube had a substantial amount of sediment in bottom. This was assumed to indicate that an excess of exfoliated layered material had been utilized. 5.0 ml of the liquid was decanted and put into another sterile container using aseptic techniques and labeled KB003-7. A portion of KB003-7 was cultured. An analysis of the culture was conducted after 48 hours, which revealed that biological organisms had proliferated to a growth rate of 12 CFU/ml.

These methods may be further enhanced by first preparing a suspension of layered materials with quantities of bio-toxic materials included between restacked layers in a concentrated suspension. Then applying this modified material in the manner described in the foregoing experiment.

### Experiment 3

A third series of experiments were conducted in order to combine the techniques described in the previous experiments with the addition of exfoliated layered materials containing defined dosages of bio-toxic materials as inclusions.

A 250 ml suspension containing approximately 20 mg/ml of exfoliated MoS₂ in isopropyl alcohol was concentrated by centrifuging for 30 minutes at 3000 rpm. The excess alcohol was decanted and a concentrated paste containing a defined dosage of alcohol and containing approximately 60 mg/ml of exfoliated MoS₂ was recovered. A sample containing 0.5 ml of this concentrate was added in a centrifuge tube to 15 ml of “control water” sample KB300-1. The sample was shaken vigorously to re-suspend the layered material and centrifuged for 10 minutes at 3000 RPM. 5.0 ml of the liquid was decanted and put into another sterile container using aseptic techniques and labeled KB007-8. A portion of KB007-8 was cultured. An analysis of the culture was conducted after 48 hours which revealed that biological organisms had proliferated to a growth rate of 0 CFU/ml.

These experiments clearly demonstrate that the ability of an excess of exfoliated layered materials, with and without bio-toxic inclusions, to effectively remove microorganisms from contaminated water. As will be apparent to those skilled in the art in the light of the foregoing disclosure, many alterations and modifications are possible in the practice of this invention without departing from the spirit or scope thereof.

We claim:

1. Methods for removing living microorganisms or other living biological materials, from polar solvents containing suspensions of said microorganisms or other biological materials, by including said materials within layers of homogenously dispersed layered materials. Said methods being comprised of means for:
Insuring that an excess amount of a homogenous dispersion of suspended layered material in relation to the biological contaminants in the solvent is added to a solvent that contains impurities in the form of living microorganisms.
Agitating the mixture of materials in such a manner and for sufficient time to cause particles of the suspended layered materials to come into contact with the impurity.
Separating the layered material containing within its layers the now included impurities from the remainder of the now pure solvent.

2. Methods for removing living or dead microorganisms or other living or dead biological materials, from polar solvents containing suspensions of said microorganisms or other biological materials, by including said materials within layers of homogenously dispersed layered materials. Said methods being comprised of means for:
Preparing a concentrated suspension of exfoliated layered materials with quantities of bio-toxic materials contained as inclusions within the spaces separating restacked layers of the exfoliated layered material in the concentrate.
Insuring that an excess amount of said concentrated suspension of layered material with bio-toxic inclusions, in relation to the contaminants in the solvent, is added to, and homogenously dispersed in, a solvent which contains impurities in the form of living or dead microorganisms or other biological material.
Agitating the mixture of materials in such a manner and for sufficient time to cause particles of the suspended layered materials to come into contact with the impurity.
Separating the layered material containing within its layers, the now included impurities, from the remainder of the now pure solvent.

3. The methods of claim 2 where the bio-toxin inclusion is comprised of a polar solvent.

4. The inclusion material of claim 3 where the bio-toxin is alcohol.

5. The method of claim 2 where the bio-toxin inclusion is comprised of materials immiscible, or suspended, or dissolved in a polar solvent.

6. The method of claim 2 where the quantity of the bio-toxin material is adjusted by concentrating the suspension of layered material.
